(19) United States
(12) Patent Application Publication
(10) Pub. No.: US 2026/0122404 A1
(43) Pub. Date: Apr. 30, 2026

(54) EARPHONES

(71) Applicant: SHENZHEN SHOKZ CO., LTD., Shenzhen (CN)

(72) Inventors: Yingying ZHANG, Shenzhen (CN); Song YOU, Shenzhen (CN); Haochen LIU, Shenzhen (CN); Yueqiang WANG, Shenzhen (CN); Yiling REN, Shenzhen (CN)

(73) Assignee: SHENZHEN SHOKZ CO., LTD., Shenzhen (CN)

(21) Appl. No.: 19/432,065

(22) Filed: Dec. 23, 2025

Related U.S. Application Data
(63) Continuation of application No. PCT/CN2024/096473, filed on May 30, 2024.

(51) Int. Cl. H04R 1/10

(52) U.S. Cl. CPC H04R 1/1075; H04R 1/1008; H04R 2460/13

(57) ABSTRACT

A wearing assembly and an earphone are disclosed. The wearing assembly includes a headband assembly including: a clamping member arranged in a curved shape along a length direction of the clamping member, the headband assembly is wound at a periphery of a user's head in a wearing state and provides a clamping force; an elastic covering body covering the clamping member; an elastic abutment portion; and a connection portion. The elastic abutment portion is disposed on a side of the elastic covering body close to a top of the head to abut against the top of the head in the wearing state, the elastic abutment portion includes two end portions disposed along a length direction of the elastic abutment portion and an intermediate portion connecting the two end portions, the two end portions are connected to the elastic covering body, respectively, the intermediate portion is spaced apart from the elastic covering body along a direction away from the top of the head in a natural state; and the connection portion connects the intermediate portion to the elastic covering body.

### CROSS-REFERENCE TO RELATED APPLICATION

The application is a Continuation of International Application No. PCT/CN2024/096473 filed on May 30, 2024, the contents of which are entirely incorporated herein by reference.

### TECHNICAL FIELD

The present disclosure relates to the technical field of sound generation devices, and in particular to wearing assemblies and earphones.

### BACKGROUND

With the increasing proliferation of electronic devices, the electronic devices have become indispensable social and entertainment tools in people's daily lives, and people's requirements for the electronic devices are also increasing. The electronic devices (e.g., earphones, smart glasses) have also been widely used in people's daily life, which can be used in conjunction with terminal devices (e.g., mobile phones, computers, etc.) to provide users with an auditory feast. However, the wearing effect of some existing headphones in the office or business environment fails to satisfy user requirements.

### SUMMARY

The present disclosure provides a wearing assembly including a headband assembly. The headband assembly includes: a clamping member arranged in a curved shape along a length direction of the clamping member, the headband assembly is wound at a periphery of a user's head in a wearing state and provides a clamping force; an elastic covering body covering the clamping member; an elastic abutment portion; and a connection portion. The elastic abutment portion is disposed on a side of the elastic covering body close to a top of the head to abut against the top of the head in the wearing state. The elastic abutment portion includes two end portions disposed along a length direction of the elastic abutment portion and an intermediate portion connecting the two end portions. The two end portions are connected to the elastic covering body respectively, and the intermediate portion is spaced apart from the elastic covering body along a direction away from the top of the head in a natural state. The connection portion connects the intermediate portion to the elastic covering body.

In some embodiments, the elastic covering body, the elastic abutment portion, and the connection portion enclose to form an airbag, the airbag including a cavity and an opening connecting the cavity to the outside.

In some embodiments, in the wearing state, the connection portion and the opening are respectively disposed on two sides of the elastic covering body opposite to each other along a sagittal axis direction of a human body, and the connection portion and the opening are respectively disposed on two sides of the elastic abutment portion opposite to each other along the sagittal axis direction.

In some embodiments, in the wearing state, a distance between the connection portion and a front side of the user is smaller than a distance between the opening and the front side of the user along the sagittal axis direction of the human body.

In some embodiments, the elastic covering body, the elastic abutment portion, and the connection portion are integrally molded.

In some embodiments, the headband assembly further includes a first enclosure portion connected to the elastic abutment portion and a second enclosure portion connected to the elastic covering body, and the first enclosure portion and the second enclosure portion enclose to form the opening.

In some embodiments, in the natural state, a size of the opening along the length direction of the clamping member is smaller than a size of the cavity along the length direction of the clamping member, and/or, a size of the opening along a thickness direction of the clamping member is smaller than a size of the cavity along the thickness direction of the clamping member.

In some embodiments, the cavity and the opening are arranged in a strip shape and extends along the length direction of the clamping member, respectively, and in the natural state, a ratio of a length of the opening to a length of the cavity is within a range from 0.5 to 1.

In some embodiments, the cavity is arranged in a strip shape, the opening includes at least two openings spaced apart along the length direction of the clamping member, and in the natural state, a ratio of a total length of the at least two openings to a length of the cavity is within a range from 0.5 to 1.

In some embodiments, the airbag is symmetrically disposed with respect to a center position of the headband assembly along the length direction of the headband assembly, and in the natural state, a ratio of a length of the cavity along a length direction of the clamping member to a length of the clamping member is within a range from 0.5 to 0.8.

In some embodiments, in the natural state, a maximum spacing distance between the intermediate portion and the elastic covering body is within a range from 1 millimeter (mm) to 5 mm.

In some embodiments, the wearing assembly further includes two connection assemblies disposed at two ends of the headband assembly, respectively. For each of the connection assemblies, an end of the connection assembly is connected to one of the two ends of the headband assembly, and the other end of the connection assembly is connected to one of speaker assemblies; in the natural state, the connection assemblies intersect with each other.

In some embodiments, the wearing assembly is configured to position the speaker assemblies at a facial region anterior to the user's tragus in the wearing state, and in the wearing state, the elastic abutment portion and the top of the head form a first contact region to realize an auxiliary positioning of the wearing assembly on the head.

In some embodiments, each of the connection assemblies further includes a fixing assembly and a telescoping assembly. One end of the fixing assembly is connected to one of the two ends of the headband assembly, one end of the telescoping assembly is inserted into the fixing assembly from the other end of the fixing assembly, and the other end of the telescoping assembly is connected to one of the speaker assemblies, and the telescoping assembly is configured to adjust a wearing position of the speaker assemblies connected to the connection assembly by telescoping with respect to the fixing assembly; in the wearing state, the fixing assembly and a side surface of the head form a second contact region, and the first contact region and the second contact region cooperate to realize the auxiliary positioning of the wearing assembly on the head.

The present disclosure provides an earphone including the wearing assembly of any one of the above embodiments and the speaker assemblies connected to the wearing assembly. The wearing assembly is configured to position the speaker assemblies at the facial region anterior to the user's tragus in the wearing state.

In some embodiments, each of the speaker assemblies includes a housing assembly, and a bone conduction speaker and/or an air conduction speaker disposed in the housing assembly.

The present disclosure provides a wearable assembly including two headband assemblies, and two soft abutment portions. The headband assembly is wound at a periphery of a user's head in a wearing state and provides a clamping force. Two ends of the headband assembly are connected to the connection assemblies, respectively, along an extension direction of the headband assembly. The connection assemblies are configured to connect the speaker assemblies, each of the connection assemblies is provided with one of the soft abutment portions on a side of the connection assembly close to the head in the wearing state. Each of the soft abutment portions is configured to abut against a side surface of the head to realize a positioning of the wearing assembly on the head. A contact surface between each of the soft abutment portions and the head has a length direction and a width direction, the length direction of the contact surface being disposed along the extension direction of the headband assembly, and a maximum size of the contact surface along the length direction being larger than a maximum size of the contact surface along the width direction.

In some embodiments, in the wearing state, a contact length between the contact surface and the head along the length direction of the contact surface is within a range from 25 mm to 50 mm.

In some embodiments, in the wearing state, a contact area between the contact surface and the head is within a range from 150 square millimeters (mm²) to 400 mm².

In some embodiments, each of the connection assemblies includes a housing and a telescoping assembly, the housing includes a first end and a second end opposite to each other along the extension direction of the headband assembly. The first end of the housing is connected to a corresponding end of the headband assembly, one end of the telescoping assembly is inserted into the housing from the second end of the housing, the other end of the telescoping assembly is connected to one of the speaker assemblies, the telescoping assembly is configured to adjust a wearing position of the corresponding speaker assembly by telescoping with respect to the housing; the soft abutment portions corresponding to the connection assembly is disposed on a side of the housing close to the head in the wearing state.

In some embodiments, in a natural state, a spacing distance between the second ends of the housings of the connection assemblies is within a range from 30 mm to 60 mm, and a thickness of each of the soft abutment portions is within a range from 3 mm to 7 mm, in the wearing state, a thickness direction of the soft abutment portions is a direction close to or away from the side surface of the head.

In some embodiments, when the spacing distance between the second ends of the two housings is opened to a range from 150 mm to 170 mm, a clamping force between the two second ends of the two housings is within a range from 78 g to 90 g, and the two soft abutment portions are arranged so that in the wearing state, a clamping force between the speaker assemblies connected by the two connection assemblies is within a range from 35 g to 50 g.

In some embodiments, for each of the connection assemblies, the housing of the connection assembly is detachably connected to the soft abutment portion corresponding to the connection assembly.

In some embodiments, the soft abutment portions include at least two groups of soft abutment portions, the thicknesses of different groups of soft abutment portions are different, and in the wearing state, the thickness direction of the groups of soft abutment portions is a direction close to or away from the side surface of the head.

In some embodiments, for each of the housings, an extension wall is disposed on a side of the housing close to the head, the extension wall and the housing enclose to form a positioning groove, the side of the housing close to the head in the wearing state forms a bottom wall of the positioning groove, the extension wall forms a sidewall of the positioning groove, and a portion of the soft abutment portion that is connected to the housing is detachably disposed within the positioning groove.

In some embodiments, the wearing assembly further includes a hook-and-loop fastener including a hook patch and a furry patch. The hook patch is disposed on the bottom wall of the positioning groove, the furry patch is disposed on a side of the soft abutment portions that is connected to the housing, or the furry patch is disposed on the bottom wall of the positioning groove, and the hook patch is disposed on the side of the soft abutment portion that is connected to the housing, the soft abutment portions is detachably connected to the housing through the hook-and-loop fastener.

In some embodiments, the wearing assembly further includes a wire threaded through the headband assembly and the housing, a wiring groove is disposed on the bottom wall of the positioning groove, two ends of the housing along a telescoping direction of the telescoping assembly are provided with a wire inlet and a wire outlet, the wire is threaded into the positioning groove via the wire inlet embedded in the wiring groove, and threaded out of the positioning groove via the wiring outlet.

In some embodiments, in the wearing state, the headband assembly and the top of the head form a first contact region, and each of the soft abutment portions and the side surface of the head form a second contact region, the first contact region and the second contact region are configured to achieve the positioning of the wearing assembly on the head.

In some embodiments, in the natural state, the two connection assemblies intersect with each other.

In some embodiments, each of the soft abutment portions includes a sponge main body and a fabric wrapping the sponge main body, and a surface of the fabric is provided with dots or strips of silicone arranged in an array.

In some embodiments, for each of the soft abutment portions, in the length direction, the soft abutment portions includes a first end and a second end opposite to each other, in the natural state, thicknesses of the first end and the second end are different, and in the wearing state, a thickness direction of the soft abutment portions is close to or away from the side surface of the head.

In some embodiments, a thickness difference between the first end and the second end is within a range from 0.8 mm to 3 mm, or, the thickness of one of the first end and the second end is less than the thickness of the other of the first end and the second end, and in a direction from the one to the other, the thickness of the soft abutment portions gradually increases.

The present disclosure provides an earphone including the wearing assembly of any one of the above embodiments and the speaker assemblies connected to the wearing assembly. The wearing assembly is configured to position the speaker assemblies at the facial region anterior to the user's tragus in the wearing state.

In some embodiments, each of the speaker assemblies includes a housing assembly, and a bone conduction speaker and/or an air conduction speaker disposed in the housing assembly.

The present disclosure provides a speaker assembly including a housing assembly and a bone conduction speaker. The bone conduction speaker includes a core housing, a transducer, a vibration transmission contact assembly, and an auxiliary contact assembly. The core housing is supported on the housing assembly, and at least a portion of the core housing is exposed from the housing assembly. The transducer is disposed inside the core housing. The vibration transmission contact assembly is connected to the transducer, and the vibration transmission contact assembly contacts a facial region anterior to a user's tragus in an wearing state. The auxiliary contact assembly includes a fixing ring and a silicone contact member. The fixing ring is sleeved on the core housing, and the silicone contact member includes a contact main body and an annular flange sleeved on an outer annular surface of the fixing ring. The contact main body is provided with a through hole, the annular flange is connected to a side of the contact main body facing the core housing at a periphery of the through hole, the vibration transmission contact assembly is exposed through the through hole, and the contact main body contacts the facial region at a periphery of the vibration transmission contact assembly in the wearing state.

In some embodiments, in the wearing state, the contact main body has a first side facing the tragus and a second side away from the tragus, and that a ratio of a width of the first side to a width of the second side is within a range from 5 to 10.

In some implementations, the width of the first side is within a range from 0.5 mm to 3 mm.

In some embodiments, an outer wall surface of the core housing and an inner annular surface of the fixing ring are respectively provided with clamping structures that cooperates with each other.

In some embodiments, along a direction facing a middle portion of the through hole, a distance between a hole edge of the through hole and the middle portion of the through hole is smaller than a distance between the inner annular surface of the fixing ring and the middle portion of the through hole.

In some embodiments, along the direction facing the middle of the through hole, a spacing distance between the hole edge of the through hole and the inner annular surface of the fixing ring is within a range from 1 mm to 3 mm.

In some embodiments, the contact main body and the annular flange are integrally molded and are fixed to the fixing ring by molding.

In some embodiments, in a natural state, a contact surface of the contact main body for contacting the facial region extends toward a side of the vibration transmission contact assembly away from the housing assembly.

In some embodiments, a thickness of the contact main body gradually decreases along a direction away from the through hole or, the other side of the contact main body away from the contact surface gradually decreases along a direction facing the housing assembly.

In some embodiments, the speaker assemblies further includes an air conduction speaker disposed in the housing assembly. The air conduction speaker is provided with a first sound outlet, and the housing assembly is provided with a second sound outlet corresponding to the first sound outlet. When viewed along a vibration direction of the vibration transmission contact assembly, the second sound outlet is located at a periphery of the silicone contact member, and the second sound outlet is disposed on a side of the silicone contact member facing the tragus in the wearing state.

The present disclosure provides an earphone including a speaker assemblies of any one of the above embodiments and the wearing assembly connected to the speaker assemblies. The wearing assembly is configured to position the speaker assembly at the facial region anterior to the user's tragus in the wearing state.

It should be noted that the general descriptions and following detailed descriptions are merely exemplary and explanatory, and are not intended to limit the present disclosure.

### BRIEF DESCRIPTION OF THE DRAWINGS

In order to more clearly illustrate the technical solutions in the embodiments of the present disclosure, the following will briefly introduce the drawings that need to be used in the description of the embodiments or the prior art. Obviously, the drawings in the following description are merely some embodiments of the present disclosure. For those of ordinary skill in the art, other drawings may also be obtained according to these drawings without creative work.

FIG. 1 is a schematic diagram illustrating a three-dimensional (3D) structure of an earphone according to some embodiments of the present disclosure;

FIG. 2 is a schematic diagram illustrating an exploded structure of the earphone shown in FIG. 1;

FIG. 3 is a schematic diagram illustrating 3D structures of an elastic covering body, an elastic abutment portion, and a connection portion shown in FIG. 2;

FIG. 4 is a schematic diagram illustrating a connection structure of the elastic covering body, the elastic abutment portion, and the connection portion of a headband assembly shown in FIG. 1;

FIG. 5 is a schematic diagram illustrating a section of the headband assembly at a symmetry plane a-a shown in FIG. 1;

FIG. 6 is a schematic diagram illustrating a structure of a section c-c of the headband assembly shown in FIG. 5;

FIG. 7 is a schematic diagram illustrating an exploded structure of the connection assembly shown in FIG. 2;

FIG. 8 is a schematic diagram illustrating a structure of a section b-b of the connection assembly shown in FIG. 1;

FIG. 9 is a schematic diagram illustrating a forward structure of an elastic abutment portion shown in FIG. 7;

FIG. 10 is a schematic diagram illustrating a lateral structure of an elastic abutment portion shown in FIG. 7;

FIG. 11 is a schematic diagram illustrating 3D structures of a headband assembly and a connection assembly shown in FIG. 1;

FIG. 12 is a schematic diagram illustrating a forward structure of a second housing shown in FIG. 7;

FIG. 13 is a schematic diagram illustrating a structure of a section d-d of a speaker assembly shown in FIG. 1;

FIG. 14 is a schematic diagram illustrating a 3D structure of a silicone contact member shown in FIG. 2;

FIG. 15 is a schematic diagram illustrating exploded structures of a fixing ring and a core housing shown in FIG. 2; and

FIG. 16 is a schematic diagram illustrating a structure of a section e-e of the silicone contact member shown in FIG. 14.

### DETAILED DESCRIPTION

To enable those skilled in the art to better understand the technical solutions of the present disclosure, the charging box provided herein is described in further detail below in conjunction with the accompanying drawings and specific embodiments. It is to be understood that the described embodiments are only a portion of the embodiments of the present disclosure, and not all of them. Based on the embodiments of the present disclosure, all other embodiments obtained by those skilled in the art without making creative labor fall within the scope of protection of the present disclosure.

The terms “first,” “second,” etc., in the present disclosure are used to differentiate between different objects, and are not used to describe a particular order. Additionally, the terms “comprising” and “having,” and any variations thereof, are intended to cover non-exclusive objects. For example, a process, a method, a system, a product, or a device that includes a series of operations or units is not limited to the listed operations or units, but optionally also includes operations or units that are not listed, or optionally, also includes other operations or units inherent to the process, the method, the product, or the device.

The following is an exemplary structure of an earphone 1 according to some embodiments of the present disclosure.

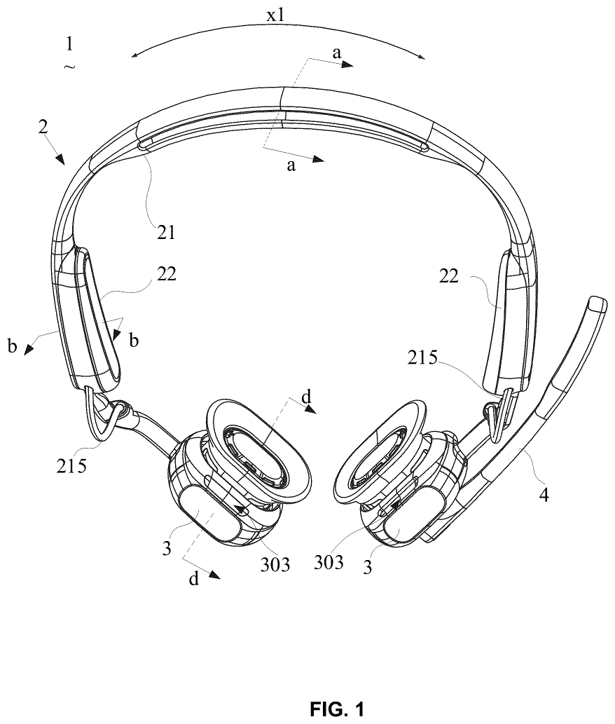

As shown in FIG. 1, the earphone 1 may include a wearing assembly 2, speaker assemblies 3, and a stick microphone assembly 4. A count of the speaker assemblies 3 may be two. The two speaker assemblies 3 are used to transmit a vibration and/or a sound to a user's left and right ears, respectively. The two speaker assemblies 3 may be the same or different. For example, one speaker assembly 3 is provided with the stick microphone assembly 4, and the other speaker assembly 3 is not provided with the stick microphone assembly 4.

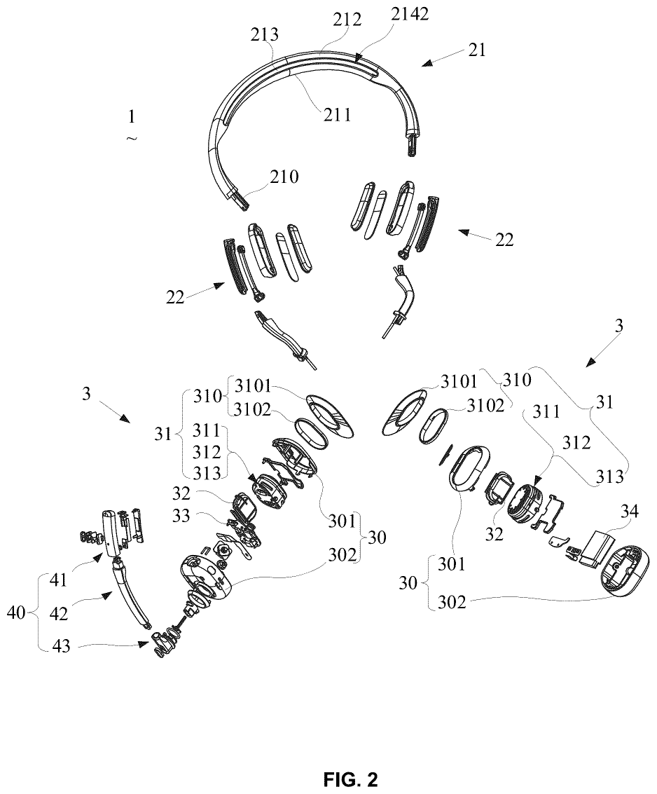

As shown in FIG. 2, the wearing assembly 2 includes a headband assembly 21 and connection assemblies 22. A count of the connection assemblies 22 may be two. Two ends of the headband assembly 21 are connected to the two connection assemblies 22, respectively. The two connection assemblies 22 are connected to the two speaker assemblies 3, respectively. The headband assembly 21 is used to go around a top of the user's head, and a shape of the headband assembly 21 may be matched with a contour of the user's head, thereby improving the comfort and stability when the user wears the headband assembly 21. The headband assembly 21 is also used to elastically clamp two sides of the user's head. The connection assembly 22 is capable of telescopic movement to change a length of the connection assembly 22 itself, thereby changing distances between the headband assembly 21 and the speaker assemblies 3. Therefore, the distances can be adaptively adjusted according to different head shapes of users, thereby positioning the speaker assemblies 3 in suitable positions, and improving a compatibility of the wearing assembly 2.

As shown in FIG. 2, the speaker assemblies 3 may include housing assemblies 30, a bone conduction speaker 31, and an air conduction speaker 32. The speaker assemblies 3 may also include at least one of a battery 34 or a control circuit board 33. The housing assemblies 30 are used to accommodate the bone conduction speaker 31 and the air conduction speaker 32. The bone conduction speaker 31 is used to contact the user's face, and the air conduction speaker 32 is used to transmit air conduction sound waves to the user's ear canal. When the earphone 1 is worn on the user's head, the wearing assembly 2 may position the speaker assemblies 3 at a facial region anterior to the user's tragus. As shown in FIG. 2, for example, one of the speaker assemblies 3 includes the control circuit board 33, and the other speaker assemblies 3 does not include the control circuit board 33, but includes the battery 34. A connection wire between the two speaker assemblies 3 is threaded across the wearing assembly 2. For example, one of the speaker assemblies 3 includes the control circuit board 33 and the battery 34. Alternatively, there may be two control circuit boards 33, and each of the speaker assemblies 3 includes one control circuit board 33. There may be two batteries 34, and each of the speaker assemblies 3 includes one battery 34.

As shown in FIG. 2, each of the housing assemblies 30 may include a main housing 302 and a main cover body 301. The main housing 302 may have an open end, and the main cover body 301 caps the open end of the main housing 302. The main cover body 301 may be provided with a sound outlet (i.e., a second sound outlet as described below) for the air conduction speaker 32 to emit sound. A portion of the bone conduction speaker 40 may be exposed through the open end of the main housing 31 for contacting the user's face. The bone conduction speaker 31 and the air conduction speaker 32 may be perpendicular to each other, and are assembled in the main housing 302 in a manner where a vibration direction of the bone conduction speaker 31 is perpendicular to a vibration direction of the air conduction speaker 32, to minimize a mutual interference between the bone conduction speaker 31 and the air conduction speaker 32. The bone conduction speaker 31 is disposed with an auxiliary contact assembly 310 for a contact comfort. The auxiliary contact assembly 310 is used to increase a contact area between the bone conduction speaker 31 and the user's face in a wearing state, thereby improving a wearing comfort.

The stick microphone assembly 4 is rotatably disposed at the speaker assemblies 3. The stick microphone assembly 4 may include a stick body assembly 42, a microphone assembly 41, and a shaft mechanism 43. The microphone assembly 41 and the shaft mechanism 43 are connected at two ends of the stick body assembly 42, and the shaft mechanism 43 is rotatably connected to the speaker assemblies 3. In the wearing state, the shaft mechanism 43 may position the microphone assembly 41 at a sound pickup region of the user's mouth by rotating with respect to the speaker assemblies 3. The microphone assembly 41 is provided with at least one microphone and at least one related button. The at least one related button may be configured to turn on or off the at least one microphone.

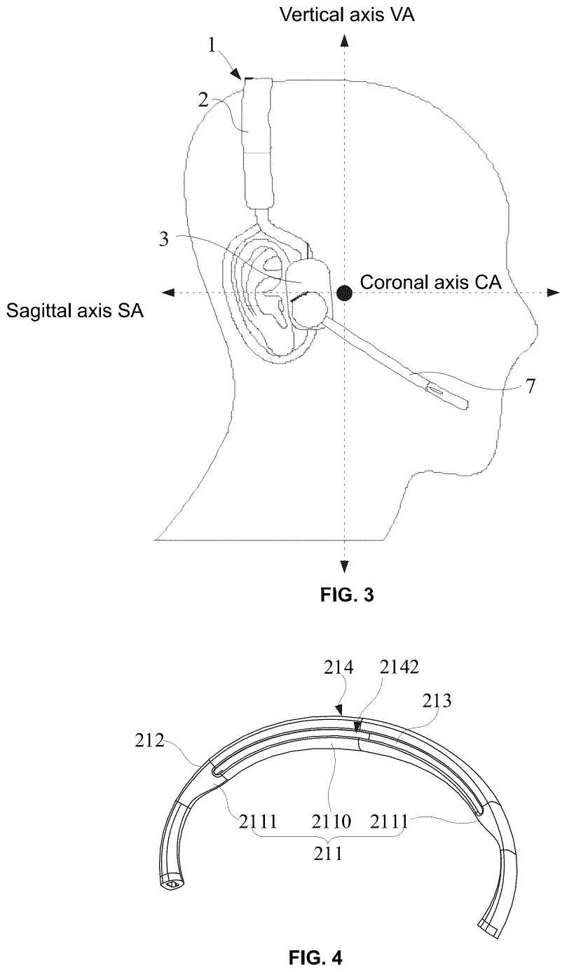

In fields of medicine, anatomy, etc., three basic sections (a sagittal plane, a coronal plane, and a horizontal plane) and three basic axes (a sagittal axis, a coronal axis, and a vertical axis) of a human body may be defined. The sagittal plane refers to a section along an anterior-posterior direction of the body and perpendicular to the ground, which divides the body into left and right parts. The coronal plane refers to a section along a left-right direction of the body and perpendicular to the ground, which divides the body into anterior and posterior parts. The horizontal plane refers to a section along an up-down direction of the body and parallel to the ground, which divides the body into upper and lower parts. Correspondingly, a sagittal axis SA refers to an axis along the anterior-posterior direction of the body and perpendicular to the coronal plane, the coronal axis refers to an axis along the left-right direction of the body and perpendicular to the sagittal plane, and the vertical axis VA refers to an axis along the upper-lower direction of the body and perpendicular to the horizontal plane. As shown in FIG. 3, when wearing the earphone 1, the wearing assembly 2 is clamped on the two sides of the user's head, and the speaker assemblies 3 are located at the facial region anterior to the tragus along the sagittal axis SA.

The following contents will describe the earphone 1 or some of the above-mentioned components, structures, etc., in detail. It should be understood that, some of the above-mentioned structures, components, such as the bone conduction speaker 31, the air conduction speaker 32, etc., can be used not only in the earphone 1, but also in other electronic devices, such as a mobile phone, a speaker, a smart wearable device, etc.

The following contents mainly describe exemplary structures of the wearing assembly 2, the speaker assemblies 3, etc. of the earphone 1.

Preferably, as shown in FIGS. 1 and 2, in some embodiments, the headband assembly 21 may include a clamping member 210, an elastic covering body 212, an elastic abutment portion 211, and a connection portion 213. The clamping member 210 is arranged in a curved shape along a length direction of the clamping member 210, and the headband assembly 21 is wound at a periphery of the top of the user's head in the wearing state and provides a clamping force for the entire headband assembly 21. Therefore, the entire headband assembly 21 can maintain a stable clamping posture with a human head, thereby effectively ensuring the wearing stability of the earphone 1. The elastic covering body 212 covers around the clamping member 210, thereby effectively improving the aesthetics and the wearing comfort of the earphone 1. Further, the elastic abutment portion 211 is disposed on a side of the elastic covering body 212 close to the top of the head to abut against the top of the head in the wearing state. In this way, the entire headband assembly 21 abuts against the head of the human body through the elastic abutment portion 211, so as to effectively improve the wearing comfort of the earphone 1. At the same time, in the wearing state, the elastic abutment portion 211 serves as one of contact regions (also referred to as a first contact region) of the earphone 1 where the earphone 1 contacts the human body, so as to realize an auxiliary positioning of the wearing assembly 2 on the head, and cooperates with other contact points between the earphone 1 and the human body, so that the earphone 1 forms at least a three-point contact with the head in the wearing state. For example, in some embodiments, in the wearing state, the two speaker assemblies 3 of the earphone 1 are positioned at the facial region anterior to the user's tragus in the wearing state, respectively, so as to cooperate with the wearing assembly 2 to form the three-point contact, thereby effectively improving the wearing stability of the earphone 1.

Further, as shown in FIG. 4, the elastic abutment portion 211 includes two end portions 2111 disposed along a length direction of the elastic abutment portion 211 and an intermediate portion 2110 connecting the two end portions 2111. The two end portions 2111 are connected to the elastic covering body 212, respectively, and the intermediate portion 2110 is spaced apart from the elastic covering body 212 along a direction away from the top of the head in a natural state. Specifically, in the wearing state, the intermediate portion 2110 is closer to the user's head than the elastic covering body 212 (i.e., a distance between the intermediate portion 2110 and the user's head is smaller than a distance between the elastic covering body 212 and the user's head), and the intermediate portion 2110 is spaced apart from the elastic covering body 212. In this way, the elastic abutment portion 211 can deform under an action of the clamping member 210, and a sufficient deformation space can be reserved for the elastic abutment portion 211, thereby effectively preventing an interference between the elastic covering body 212 and the elastic abutment portion 211. Therefore, the elastic abutment portion 211 can smoothly deform in the wearing state, and the elastic abutment portion 211 can be better adapted to the contour of the user's head to ensure that the contact portion stably abuts against the head, thereby effectively improving the stability and the wearing comfort of the earphone 1.

In addition, the connection portion 213 connects the intermediate portion 2110 to the elastic covering body 212, so that the connection portion 213 provides a constraining force for the clamping member 210 and the elastic abutment portion 211. In this way, the risk of relative shaking between the clamping member 210 and the elastic abutment portion 211 along a direction parallel to the sagittal axis can be minimized, thereby effectively improving the wearing stability of the wearing assembly 2, and further effectively improving the wearing stability of the earphone 1.

It should be noted that, in some embodiments, the length direction of the clamping member 210 is also referred to as a length direction x1 of the headband assembly 21, and the length direction of the elastic abutment portion 211 is disposed parallel to the length direction x1 of the headband assembly 21.

Optionally, in some embodiments, the connection portion 213 may be a grid structure. The connection portion 213 is disposed on a side of the elastic covering body 212 and the elastic abutment portion 211 along a normal direction of the length direction of the clamping member 210. In this way, the risk of relative shaking between the clamping member 210 and the elastic abutment portion 211 along the direction parallel to the sagittal axis can be minimized, and an overall mass of the wearing assembly 2 can be effectively reduced.

Preferably, as shown in FIGS. 4-6, in this embodiment, the connection portion 213, the elastic covering body 212, and the elastic abutment portion 211 enclose to form an airbag 214. The airbag 214 includes a cavity 2141 and an opening 2142 connecting the cavity 2141 to the outside. Specifically, the connection portion 213 is disposed on the side of the elastic covering body 212 and the elastic abutment portion 211 along the normal direction of the length direction of the clamping member 210, and the connection portion 213 is in a continuous enclosure structure. The connection portion 213, the elastic covering body 212, and the elastic abutment portion 211 enclose to form the half-closed airbag 214, thereby effectively minimizing the risk of relative shaking between the clamping member 210 and the elastic abutment portion 211 along the direction parallel to the sagittal axis, and effectively improving the comfort of the top of the head when the wearing assembly 2 is worn. And, the cavity 2141 is formed between the elastic covering body 212 and the elastic abutment portion 211, and the cavity 2141 is connected to the outside through the opening 2142. When the elastic abutment portion 211 deforms, the cavity 2141 is compressed, the air in the cavity 2141 may be discharged from the opening 2142, thereby effectively reducing a deformation resistance of the elastic abutment portion 211. Therefore, the elastic abutment portion 211 can smoothly deform and abut against the user's head, which increases a friction of a contact surface between the elastic abutment portion 211 and the user's head, thereby effectively ensuring the wearing stability of the earphone 1.

Preferably, as shown in FIGS. 4-6, in some embodiments, the elastic covering body 212, the elastic abutment portion 211, and the connection portion 213 may be integrally molded. That is, the elastic covering body 212, the elastic abutment portion 211, and the connection portion 213 are integrally molded, e.g., through an injection process, etc. In this way, a structural stability and an appearance consistency of the elastic covering body 212, the elastic abutment portion 211, and the connection portion 213 can be effectively improved, thereby effectively improving the overall aesthetics of the earphone 1.

Preferably, as shown in FIGS. 4-6, in some embodiments, in the wearing state, the connection portion 213 and the opening 2142 of the airbag 214 are disposed on two sides of the elastic covering body 212 opposite to each other along the direction parallel to the sagittal axis of the human body, and the connection portion 213 and the opening 2142 of the airbag 214 are disposed on two sides of the elastic abutment portion 211 opposite to each other along the direction parallel to the sagittal axis of the human body. In this way, in the wearing state, the airbag 214 has a sufficiently number of solid regions contacting the user's head, thereby effectively increasing the contact region between the airbag 214 and the head, and effectively improving the wearing stability of the earphone 1.

Preferably, as shown in FIGS. 4-6, in some embodiments, the connection portion 213 is closer to a front side of the user along a sagittal axis direction of the human body (i.e., the direction parallel to the sagittal axis) than the opening 2142 of the airbag 214 in the wearing state (i.e., a distance between the connection portion 213 and the front side of the user is smaller than a distance between the opening 2142 of the airbag 214 and the front side of the user along the sagittal axis direction of the human body in the wearing state). In this way, the concealability of the opening 2142 of the airbag 214 in the wearing state can be effectively improved, thereby effectively improving the aesthetics of the earphone 1.

Preferably, as shown in FIGS. 4-6, in some embodiments, the headband assembly 21 further includes a first enclosure portion 2112 connected to the elastic abutment portion 211 and a second enclosure portion 2121 connected to the elastic covering body 212. The first circumferential portion 2112 and the second circumferential portion 2121 enclose to form the opening 2142 of the airbag 214. Specifically, the first enclosure portion 2112 is disposed on a side of the elastic abutment portion 211 away from the connection portion 213 along the sagittal axis direction. One end of the first enclosure portion 2112 is connected to the elastic abutment portion 211, and the other end of the first enclosure portion 2112 extends toward the elastic covering body 212 along the normal direction of the length direction of the clamping member 210. The second enclosing portion 2121 is disposed on a side of the elastic covering body 212 away from the connection portion 213 along the sagittal axis direction. One end of the second enclosing portion 2121 is connected to the elastic covering body 212, and the other end of the second enclosing portion 2121 extends toward the elastic covering body 212 along the normal direction to of the length direction of the clamping member 210. In this way, a structural size of the opening 2142 of the airbag 214 is smaller than a structural size of the cavity 2141, thereby effectively ensuring that the elastic abutment portion 211 smoothly deforms to abut against the head, and effectively improving the aesthetics of the earphone 1. Specifically, in some embodiments, in the natural state, a size of the opening 2142 (i.e., a length h3 of the opening 2142) of the airbag 214 along the length direction of the clamping member 210 is smaller than a size of the cavity 2141 (i.e., a length h2 of the cavity 2141) along the length direction of the clamping member 210, and a size of the opening 2142 (i.e., a thickness size h4 of the opening 2142) of the airbag 214 along a thickness direction x4 (i.e., the normal direction of the length direction of the clamping member 210) of the clamping member 210 is smaller than a size of the cavity 2141 (i.e., a thickness size h1 of the cavity 2141) along the thickness direction x4 of the clamping member 210. This configuration can effectively ensure that the elastic abutment portion 211 smoothly deforms to abut against the head, and effectively improves the wearing comfort.

Optionally, as shown in FIGS. 4-6, in some embodiments, the first enclosure portion 2112 serves as a portion of the elastic abutment portion 211, and the second enclosure portion 2121 serves as a portion of the elastic covering body 212. In this way, the appearance consistency of the headband assembly 21 can be effectively improved, thereby effectively improving the aesthetics of the earphone 1.

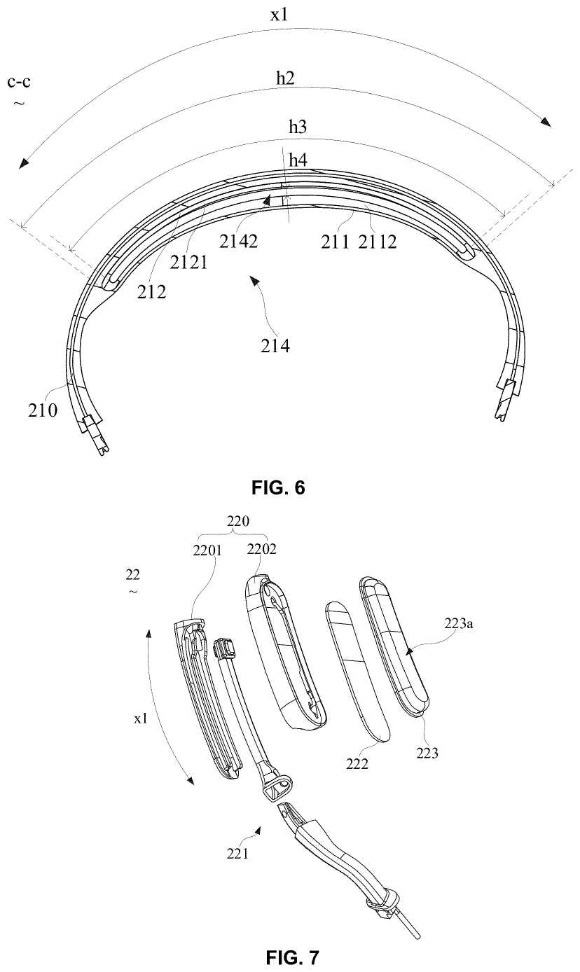

Preferably, as shown in FIG. 6, in some embodiments, the cavity 2141 and the opening 2142 of the airbag 214 are arranged in a strip shape, and extend along the length direction of the clamping member 210, respectively. In the natural state, a ratio of the length h3 of the opening 2142 to the length h2 of the cavity 2141 is within a range from 0.5 to 1. Specifically, the cavity 2141 and the opening 2142 of the airbag 214 are arranged in a smooth strip shape along the length direction of the clamping member 210, so as to facilitate a demolding process of the headband assembly 21, thereby effectively improving a production efficiency of the headband assembly 21. And, if the ratio of the length h3 of the opening 2142 to the length h2 of the cavity 2141 is too small, a difficulty of the demolding process of the airbag 214 may be increased, and the production efficiency of the headband assembly 21 may be reduced. Therefore, the ratio of the length h3 to the length h2 is within a range from 0.5 to 1. For example, the ratio may be set as any value within the range from 0.5 to 1, such as 0.5, 0.6, 0.7, 0.75, 0.8, 0.9, 1.0, etc., so as to effectively reduce the difficulty of the demolding process of the airbag 214, thereby effectively improving the production efficiency of the earphone 1 to effectively reduce a production cost of the earphone 1. In addition, in this way, the airbag can be compressed and deformed as well as restored to its original shape relatively quickly, and a wearing position of a head portion of the earphone 1 can be effectively adjusted when the user wears the earphone 1. As another example, in some embodiments, in a situation where the ratio of the length h3 to the length h2 is within the above range, the length h3 may be set to an actual size, such as 100.0 mm, 103.6 mm, 107.2 mm, and the length h2 may be set to an actual size, such as 130.0 mm, 133.7 mm, 137.4 mm, etc.

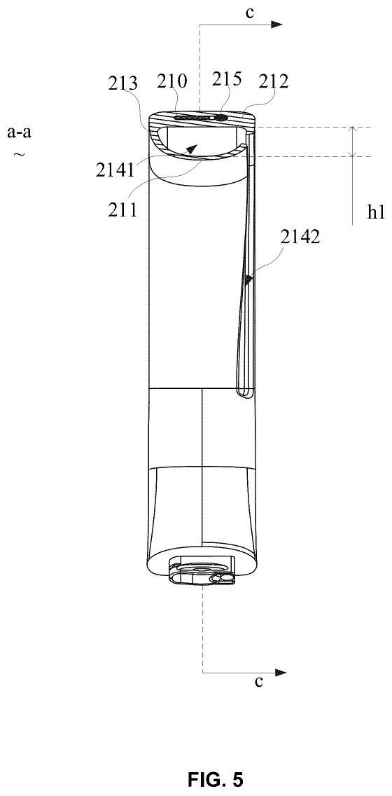

Optionally, as shown in FIG. 5, in some embodiments, the maximum thickness size of the cavity 2141 (i.e., the maximum value of the thickness size h1 of the cavity 2141) is the maximum spacing distance between the intermediate portion 2110 and the elastic covering body 212. The maximum spacing distance is equal to a distance within a range from 1 mm to 5 mm. For example, the maximum spacing distance may be set as a specific value, such as 1 mm, 2 mm, 2.1 mm, 2.2 mm, 3 mm, 4 mm, 5 mm, etc. This configuration can ensure that the maximum deformation position of the elastic abutment portion 211 (i.e., a region of the elastic abutment portion 211 corresponding to a center position of the headband assembly 21) has a sufficient deformation space, which can effectively ensure an overall bending degree of the elastic abutment portion 211, and effectively improve a contact area between the elastic abutment portion 211 and the user's head, thereby effectively improving the wearing stability of the earphone 1.

Further, as shown in FIGS. 4-6, in some embodiments, along the length direction x1 of the headband assembly 21, the thickness size h1 of the cavity 2141 gradually decreases from a middle portion of the cavity 2141 (i.e., a region of the cavity 2141 corresponding to the center position of the headband assembly 21) to two sides of the cavity 2141, respectively. The middle portion of the cavity 2141 corresponds to the center position of the headband assembly 21 in the length direction x1, and the thickness size h1 of the cavity 2141 located in the middle portion of the cavity 2141 is the maximum thickness size of the cavity 2141. In this way, the thickness size h1 of the cavity 2141 can correspond to a size of deformation at each position of the elastic abutment portion 211, thereby enabling the elastic abutment portion 211 to deform in a better way. Therefore, the contact area between the elastic abutment portion 211 and the head can be effectively increased, thereby effectively improving the wearing stability of the earphone 1.

Optionally, as shown in FIGS. 4-6, in some embodiments, along the length direction x1 of the headband assembly 21 (in some embodiments, the length direction x1 of the headband assembly 21 is also referred to as an extension direction of the headband assembly 21), the thickness dimension h1 of the cavity 2141 may also be uniformly set. The thickness size h1 is within a range from 1 to 5 mm. For example, the thickness size of the cavity 2141 h1 may be set as a specific value, such as 1 mm, 2 mm, 2.1 mm, 2.2 mm, 3 mm, 4 mm, 5 mm, etc. This configuration can effectively ensure that the elastic abutment portion 211 has the sufficient deformation space, thereby effectively ensuring the overall bending degree of the elastic abutment portion 211. Therefore, the contact area between the elastic abutment portion 211 and the user's head can be effectively improved, thereby effectively improving the wearing stability of the earphone 1.

Preferably, as shown in FIG. 1, FIG. 4, and FIG. 5, in some embodiments, the headband assembly 21 has the center position along the length direction of the headband assembly 21. The airbag 214 is symmetrically disposed with respect to the center position. Specifically, in this embodiment, the connection portion 213, the elastic abutment portion 211, and the elastic covering body 212 are symmetrically disposed with respect to the center position, so that the entire airbag 214 is symmetrically disposed with respect to the center position. In this way, an overall contour of the airbag 214 is more adapted to the contour of the user's head, thereby effectively improving the wearing stability of the headband assembly 21. Further, the cavity 2141 serves as a cavity for providing the deformation space for the elastic abutment portion 211, and the clamping member 210 serves as a component for providing the clamping force, so the bending degree of the elastic offset portion 211 in the wearing state is jointly determined by the length of the clamping member 210 and the length of the cavity 2141 along the length direction of the clamping member 210 in the natural state. Therefore, in the natural state, a ratio of the length (i.e., the length h2) of the cavity 2141 along the length direction of the clamping member 210 and the length of the clamping member 210 is within a range from 0.5 to 0.8. For example, the ratio may be set as a specific value within the range from 0.5 to 0.8, such as 0.5, 0.6, 0.7, 0.75, 0.8, etc. In this way, the bending degree of the elastic abutment portion 211 in the wearing state can be effectively ensured to cause the overall contour of the elastic abutment portion 211 to adapt to the contour of the user's head, thereby effectively increasing the contact area between the elastic abutment portion 211 and the user's head, and effectively improving the wearing stability of the earphone 1.

It should be noted that the center position can be defined as a region between two sides of a symmetry plane a-a of the headband assembly 21 and extending along the length direction x1 of the headband assembly 21 by a preset distance. The preset distance is larger than or equal to 0 mm.

Optionally, in some embodiments, a count of the opening 2142 of the airbag 213 is at least two. The at least two openings 2142 are spaced apart along the length direction of the clamping member 210. In the natural state, a ratio between a total length of the at least two openings 2142 to the length h2 of the cavity 2141 is within a range from 0.5 to 1. For example, the ratio is set as a specific value within the range from 0.5 to 1, such as 0.5, 0.6, 0.7, 0.75, 0.8, 0.9, 1.0, etc. In this way, the difficulty of the demolding process of the airbag 214 can be effectively reduced, thereby effectively improving the production efficiency of the earphone 1, and effectively reducing the production cost of the earphone 1. The total length of the plurality of openings 2142 is a sum of the lengths of the plurality of openings 2142 along the length direction of the clamping member 210. For example, when the count of the opening 2142 is two, the total length of the two openings 2142 is the sum of a length of one of the two openings 2142 along the length direction of the clamping member 210 and a length of the other opening 2142 along the length direction of the clamping member 210.

Preferably, as shown in FIGS. 1 and 2, in some embodiments, the wearing assembly 2 further includes two connection assemblies 22. Along the extension direction of the headband assembly 21 (i.e., the length direction x1 of the headband assembly 21), each end of the headband assembly 21 is connected to one connection assembly 22. That is, for each of the connection assemblies 22, one end of the connection assembly 22 is connected to one of the two ends of the headband assembly 21, and the other end of the connection assembly 22 is connected to one of the speaker assemblies 3. In the natural state, the connection assemblies 22 disposed in the two ends of the headband assembly 21 intersect with each other. Specifically, the wearing assembly 2 includes two connection assemblies 22. In the natural state, one end of each of the two connection assemblies 22 connected to one of the speaker assemblies 3 extends toward an inner side of the earphone 1, so that the two connection assemblies 22 intersect with each other. On this basis, in the natural state, under an action of the intersected posture of the two connection assemblies 22, a spacing between the two speaker assemblies 3 can be reduced, so as to facilitate the entire earphone 1 to form a clamped state with the user's head in the wearing state, thereby effectively improving the wearing stability of the earphone 1. Moreover, since the clamping force of the clamping member 210 relates to a deformation physical quantity of the clamping member 210 and its own elastic physical quantity (the elastic physical quantity is determined by a structural size and a material of the clamping member 210, which is referred to existing literature in detail). Therefore, by disposing the two connection assemblies 22 to the intersected posture, the deformation physical quantity of the clamping member 210 in the wearing state can be enhanced, so that the clamping force of the wearing assembly 2 is ensured, and the overall structural size and cost of the clamping member 210 are also effectively reduced, thereby effectively reducing the overall structural size and cost of the earphone 1.

Preferably, as shown in FIG. 7, in this embodiment, each of the connection assemblies 22 further includes a fixing assembly (not labeled) and a telescoping assembly 221. One end of the fixing assembly is connected to one of the two ends of the headband assembly 21, one end of the telescoping assembly 221 is inserted into the fixing assembly from the other end of the fixing assembly and is connected to the fixing assembly. The other end of the telescoping assembly 221 is connected to one of the speaker assemblies 3, and the telescoping assembly 221 is configured to adjust a wearing position of the speaker assembly 3 connected to the connection assembly 22 by telescoping with respect to the fixing assembly, so as to enable the earphone 1 to adapt to the users with different head sizes, thereby effectively improving the adaptability of the earphone 1. Furthermore, in the wearing state, the fixing assembly and a side surface of the head form a second contact region, and the first contact region and the second contact region cooperate to realize the auxiliary positioning of the wearing assembly 2 on the head, so that the entire wearing assembly 2 cooperates with the two speaker assemblies 3 to realize a five-point contact, thereby effectively increasing a contact area between the earphone 1 and the head, and effectively improving the wearing stability of the earphone 1.

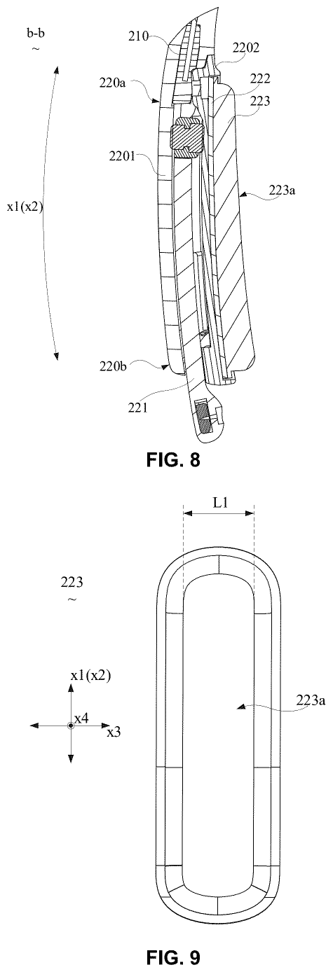

Specifically, as shown in FIG. 7 and FIG. 8, the fixing assembly further includes a housing 220. The housing 220 includes a first end 220a and a second end 220b along the extension direction of the headband assembly 21. The first end 220a of the housing 220 is connected to a corresponding end of the headband assembly 21. One end of the telescoping assembly 221 is inserted into the housing 220 from the second end 220b of the housing 220, and the other end of the telescoping assembly 221 is connected to one of the speaker assemblies 3, so that the housing 220 fixes the telescoping assembly 221 with respect to the headband assembly 21. Further, the telescoping assembly 221 is also configured to adjust the wearing position of the corresponding speaker assembly 3 by telescoping with respect to the housing 220, so as to enable the earphone 1 to adapt to the users with different head sizes, thereby effectively improving the adaptability of the earphone 1. In some embodiments, the housing 220 includes a first housing 2201 and a second housing 2202. The first housing 2201 and the second housing 2202 cooperate with each other to form an accommodation space for accommodating the telescoping assembly 221. The telescoping assembly 221 is disposed within the accommodation space.

Preferably, as shown in FIG. 7 and FIG. 8, in some embodiments, each connection assembly 22 is provided with a soft abutment portion 223 on a side close to the head in the wearing state. That is, the fixing assembly includes the soft abutment portions 223 on the side close to the head in the wearing state. The soft abutment portions 223 is disposed on a side of the housing 220 close to the head. For example, in some embodiments, the second housing 2202 is disposed closer to the head in the wearing state than the first housing 2201 (a distance between the second housing 2202 and the head is smaller than a distance between the first housing 2201 and the head). Therefore, the soft abutment portions 223 is disposed on the second housing 2202 and located on the side of the second housing 2202 close to the head. Further, each soft abutment portion 223 is configured to abut against a side surface of the head to realize the auxiliary positioning of the wearing assembly 2 on the head. In this way, the fixing assembly abuts against the side surface of the head through the soft abutment portions 223 to form the second contact region, so that the connection assemblies 22 cooperate with the headband assembly 21 (e.g. the headband assembly 21 and the head form the first contact region through the elastic abutment portions 211) and the two speaker assemblies 3 to realize the five-point contact, thereby effectively increasing the contact area between the earphone 1 and the head, and effectively improving the wearing stability of the earphone 1. And the soft abutment portions 223 are made of a soft material. In the wearing state, after the soft abutment portions 223 abut against the side surface of the head, the soft abutment portions 223 deform along the thickness direction x4 to have a certain buffer to the clamping force of the headband assembly 21, so that the clamping force of the headband assembly 21 on the two sides of the head is effectively reduced, thereby effectively improving the wearing comfort of the earphone 1.

Further, as shown in FIGS. 8 to 10, a contact surface 223a between each soft abutment portion 223 and the head has a length direction x2 and a width direction x3. The length direction of the contact surface 223a is arranged along the extension direction of the headband assembly 21. A maximum size of the contact surface 223a along the length direction x2 is larger than a maximum size of the contact surface 223a along the width direction x3. This configuration causes the contact surface 223a of the soft abutment portion 223 to extend as far as possible toward the extension direction of the headband assembly 21, which effectively improves a contact length between the contact surface 223a and the head along the length direction x2, thereby effectively improving the wearing stability of the earphone 1. At the same time, a concealment of the soft abutment portion 223 in the wearing state can be improved, thereby effectively improving the aesthetics of the earphone 1. If a length size L2 of the length direction x2 and a width size L1 of the width direction x3 of the contact surface 223a are too similar, in the case that the area of the contact surface 223a are equal, the contact surface 223a and the side surface of the head abut against in a manner similar to a “dot” contact, thereby greatly reducing a lateral damping between the soft abutment portion 223 and the head. During the wearing process, this configuration increases a risk of the earphone 1 flipping around the “dot” and falling. Therefore, the maximum size of the contact surface 223a along the length direction is larger than the maximum size along the width direction, so that the contact length of the soft abutment portion 223 along the extension direction of the headband assembly 21 is maximized. Therefore, the contact surface 223a is arranged in a “quasi-rectangle” shape, which avoids the formation of the “dot” contact between the contact surface 223a and the side surface of the head, thereby effectively improving the lateral damping between the soft abutment portions 223 and the head, and effectively minimizing the risk of the entire earphone 1 flipping and falling.

Preferably, as shown in FIG. 10, in some embodiments, in the wearing state, the contact length (i.e., the length size L2 of the contact surface 223a along the length direction x2) between the contact surface 223a and the head along the length direction x2 is within a range from 25 mm to 50 mm. For example, the contact length may be set as a specific value within the range from 25 mm to 50 mm, such as, 25 mm, 26 mm, 26.5 mm, 30 mm, 36 mm, 40 mm, 50 mm, etc. At the same time, if the contact length is too long, the stability of the contact surface 223a contacting the head along the width direction x3 may be affected. If the contact length is too short, the stability of the contact surface 223a contacting the head along the length direction x2 may be affected. Therefore, the contact length between the contact surface 223a and the head along the length direction x2 is disposed within the range from 25 mm to 50 mm, which also effectively improves the overall contact stability between the soft abutment portions 223 and the head, thereby effectively improving the wearing stability of the earphone 1.

Optionally, in some embodiments, the length size L2 of the contact surface 223a and a length size of the soft abutment portion 223 along the length direction x2 may be set as equal as possible (e.g., the length size L2 of the contact surface 223a is equal to the length size of the soft abutment portion 223), so that the soft abutment portion 223 is set as small as possible, and a general contact stability between the soft abutment portion 223 and the head is also effectively improved, thereby effectively improving the wearing stability of the earphone 1.

Furthermore, as shown in FIGS. 8 to 10, in some embodiments, the contact area between the contact surface 223a and the head in the wearing state is within a range from 150 square millimeters (mm²) to 400 mm². For example, the contact area may be set as a specific value within the range from 150 mm² to 400 mm², such as, 150 mm², 160 mm², 175 mm², 273 mm², 300 mm², 400 mm², etc. If the contact area between the contact surface 223a and the head is too small, the wearing stability and the wearing comfort of the earphone 1 may be affected. If the contact area of the contact surface 223a is too small, the cushioning ability of the soft abutment portion 223 to the force of the connection assembly 22 acting on the side surface of the head may be reduced, thereby affecting the wearing comfort of the earphone 1. If the contact area between the contact surface 223a and the head is too large, an overall volume of the soft abutment portion 223 is increased, thereby affecting a wearing ease of the earphone 1 and a miniaturization setting of the soft abutment portion 223. Therefore, by disposing the value of the contact area between the contact surface 223a and the head within the range from 150 mm² to 400 mm², the soft abutment portion 223 is miniaturized and the overall size of the earphone 1 is effectively reduced. Moreover, this configuration can effectively improve the wearing stability, the wearing comfort, and the wearing ease of the earphone 1.

Preferably, as shown in FIGS. 8 to 10, in some embodiments, the contact surface 223a is arranged in a curved shape along the length direction x2. That is, the entire contact surface 223a is arranged in a curved surface. This configuration can improve the similarity between a contour of the contact surface 223a and a contour of the side surface of the head, thereby effectively improving the compactness between the contact surface 223a and the side surface of the head, and effectively improving the wearing stability of the earphone 1.

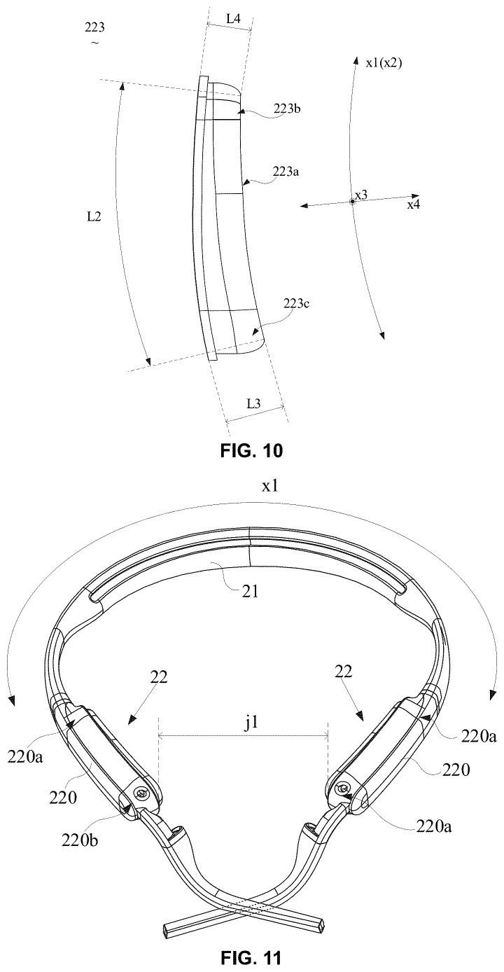

Preferably, as shown in FIG. 11, in some embodiments, in the natural state, a spacing distance j1 between two second ends 220b of two housings 220 is within a range from 30 mm to 60 mm. For example, the spacing distance may be set as an arbitrary value within the range from 30 mm to 60 mm, such as, 30 mm, 35 mm, 40 mm, 50 mm, 60 mm, etc. The spacing distance j1 between the second ends 220b of the two housings 220 directly affects a deformation quantity of the headband assembly 21 in the wearing state (i.e., a deformation quantity of the clamping member 210 in the wearing state). In this way, the overall volume of the earphone 1 in the natural state can be reduced, thereby effectively improving a portability of the earphone 1. Further, in this way, a deformation space of the clamping member 210 in the wearing state can be improved, thereby effectively improving an adjustable range of the clamping force of the wearing assembly 2, and effectively improving the adaptability of the earphone 1.

Furthermore, as shown in FIG. 10, each soft abutment portion 223 has the thickness direction x4. The thickness direction x4 of the soft abutment portion 223 is defined as a direction close to or far away from the side surface of the head in the wearing state, i.e., a direction parallel to the normal direction of the length direction of the soft abutment portion 223. The thickness (also referred to as a thickness size of the soft abutment portion 223, for example, a thickness size L4, a thickness size L3) of the soft abutment portion 223 along the thickness direction x4 is within a range from 3 mm to 7 mm. In other words, a thickness of any position of the soft abutment portion 223 (i.e., an overall thickness of the soft abutment portion 223) is within the range from 3 mm to 7 mm, and the thickness of the soft abutment portion 223 may be set unevenly. By disposing the thickness of the soft abutment portions 223 along the thickness direction x4 within the range from 3 mm to 7 mm, a cushioning ability of the soft abutment portion 223 can be improved, thereby effectively improving the wearing stability and the wearing comfort of the earphone 1.

Preferably, as shown in FIG. 11, in some embodiments, when the spacing distance j1 between the second ends 220b of the two housings 220 is opened to a range from 150 mm to 170 mm, a clamping force between the second ends 220b of the two housings 220 is within a range from 78 g to 90 g (it is to be noted that in some embodiments herein, the weight unit “gram (g)” is used to indicate a magnitude of the clamping force, and the clamping force may be converted to a Newton force unit through a Newton's mechanics formula, e.g., 78 g=0.078 kg×9.8 N/kg=0.7644 N), e.g., any value within the range from 78 g to 90 g, such as, 78 g, 79 g, 80 g, 81 g, 82 g, 83.5 g, 85 g, 90 g, etc. Specifically, in the wearing state, the spacing distance between the second ends 220b of the two housings 220 is roughly within the range from 150 mm to 170 mm. Therefore, when the spacing distance j1 between the second ends 220b of the two housings 220 is opened to the range from 150 mm to 170 mm, the clamping force between the two second ends 220b of the two housings 220 is set with the range from 78 g to 90 g, so that when the earphone 1 is in the wearing state, the clamping forces of the headband assembly 21 on the head through each connection assembly 22 (e.g., the connection assembly 22 abuts against the side surface of the head through the soft abutment portion 223) and each speaker assembly 3 (the speaker assembly 3 abuts against the corresponding facial region of the head through, for example, a silicone contact member 3101 as described below), respectively, are more reasonable, thereby effectively improving the wearing comfort and the wearing stability of the earphone 1.

Further, the two soft abutment portions 223 are arranged so that in the wearing state, a clamping force between the speaker assemblies 3 connected to the two connection assemblies 22 is within a range from 35 g to 50 g. For example, the clamping force may be set as any value within the range from 35 g to 50 g, such as, 35 g, 36 g, 37 g, 37.5 g, 40 g, 50 g, etc. In other words, in the wearing state, the clamping force between the two speaker assemblies 3 is within the range from 35 g to 50 g. This configuration can effectively ensure that the speaker assemblies 3 stably contact the user's face, and the risk of a relative displacement between the speaker assemblies 3 and the user's face can be minimized, thereby ensuring the sound transmission effect of the speaker assemblies 3, and effectively improving the wearing stability and wearing comfort of the earphone 1. Specifically, the headband assembly 21 is connected to the speaker assemblies 3 through the connection assemblies 22. It is known through mechanical analysis that the clamping force transmitted from the headband assembly 21 to the speaker assemblies 3 is affected to a certain extent by the connection assemblies 22 (e.g., components such as the soft abutment portions 223 disposed on the connection assemblies 22). Therefore, the thickness or the material of the soft abutment portions 223 may be adjusted to realize the adjustment of the clamping force between the two connection assemblies 22 (also referred to as realizing the adjustment of the clamping force between the two second ends 220b of the two housings 220), thereby realizing the adjustment of the clamping force between the two connection assemblies 22. Therefore, the clamping force between the two speaker assemblies 3 can be disposed within the range from 35 g to 50 g, thereby effectively improving the wearing stability and the wearing comfort of the earphone 1 while ensuring the sound transmission effect of the speaker assemblies 3.

Preferably, as shown in FIG. 10, in some embodiments, the thickness of each soft abutment portion 223 gradually increases along a positive direction away from the headband assembly 21 of the length direction x2 of the soft abutment portion 223. Specifically, the soft abutment portion 223 includes a first end 223b and a second end 223c opposite to each other. That is, along the positive direction away from the headband assembly 21 of the length direction x2 of the soft abutment portion 223, the first end 223b and the second end 223c are provided. In this embodiment, the first end 223b of the soft abutment portion 223 is disposed closer to the headband assembly 21. Alternatively, in some embodiments, the second end 223c of the soft abutment portion 223 is disposed closer to the headband assembly 21. Further, the thickness of the first end 223b of the soft abutment portion 223 is different from the thickness of the second end 223c of the soft abutment portion 223. The thickness of one of the first end 223b and the second end 223c of the soft abutment portion 223 that is closer to the headband assembly 21 is larger than the thickness of the other one that is away from the headband assembly 21, so that a posture of the contact surface 223a of the soft abutment portion 223 can better match the contour of the side surface of the head in the wearing state, thereby effectively ensuring that the contact surface 223a of the soft abutment portion 223 completely abuts against the side surface of the head as much as possible. Therefore, the contact area of the contact surface 223a of the soft abutment portion 223 can be effectively improved, thereby effectively improving the wearing comfort and the wearing stability of the earphone 1.

Preferably, as shown in FIG. 10, a thickness difference (i.e., an absolute value of a difference between the thickness size L3 and the thickness size L4) between the first end 223b of the soft abutment portion 223 and the second end 223c of the soft abutment portion 223 is within a range from 0.8 mm to 3 mm. For example, the thickness difference may be set as any value within the range from 0.8 mm to 3 mm, such as, 0.8 mm, 0.9 mm, 1 mm, 2 mm, 3 mm, etc. As another example, the thickness (i.e., the thickness size L4) of the first end 223b of the soft abutment portion 223 may be set to 3 mm, and the thickness (i.e., the thickness size L3) of the second end 223c of the soft abutment portion 223 may be set to 6 mm. In this way, the posture of the contact surface 223a of the soft abutment portion 223 can better match the contour of the side surface of the head in the wearing state, thereby effectively ensuring that the contact surface 223a of the soft abutment portion 223 completely abuts against the side surface of the head as much as possible. Therefore, the contact area of the contact surface 223a of the soft abutment portion 223 can be effectively improved, thereby effectively improving the wearing comfort and the wearing stability of the earphone 1.

Further, as shown in FIG. 10, in some embodiments, the thickness of one of the first end 223b of the soft abutment portion 223 and the second end 223c of the soft abutment portion 223 is less than the thickness of the other of the first end 223b of the soft abutment portion 223 and the second end 223c of the soft abutment portion 223, and in a direction from the one to the other, the thickness of the soft abutment portion 223 gradually increases. For example, in some embodiments, the first end 223b of the soft abutment portion 223 is disposed closer to the headband assembly 21, and the thickness of the soft abutment portion 223 gradually increases along a direction from the first end 223b of the soft abutment portion 223 to the second end 223c of the soft abutment portion 223. That is, the entire soft abutment portion 223 is arranged in a “quasi-trapezoidal” shape. In this way, the posture of the contact surface 223a of the soft abutment portion 223 can better match the contour of the side surface of the head in the wearing state, thereby effectively ensuring that the contact surface 223a of the soft abutment portion 223 completely abuts against the side surface of the head as much as possible. Therefore, the contact area of the contact surface 223a of the soft abutment portion 223 can be effectively improved, thereby effectively improving the wearing comfort and the wearing stability of the earphone 1.

Preferably, as shown in FIG. 8, in some embodiments, the soft abutment portion 223 is detachably disposed on the side of the housing 220 that is close to the head in the wearing state. That is, the soft abutment portion 223 is detachably connected to the housing 220. For example, the soft abutment portion 223 is detachably connected to the housing 220 through a removable connector, such as, a hook-and-loop fastener 222. This configuration can effectively improve a loading and unloading efficiency of the soft abutment portion 223, and allow the soft abutment portions 223 to be used as a replaceable part of the earphone 1. Therefore, the soft abutment portions 223 with different sizes and types can be replaced for different groups of users, effectively improving the wearing efficiency of the earphone 1.

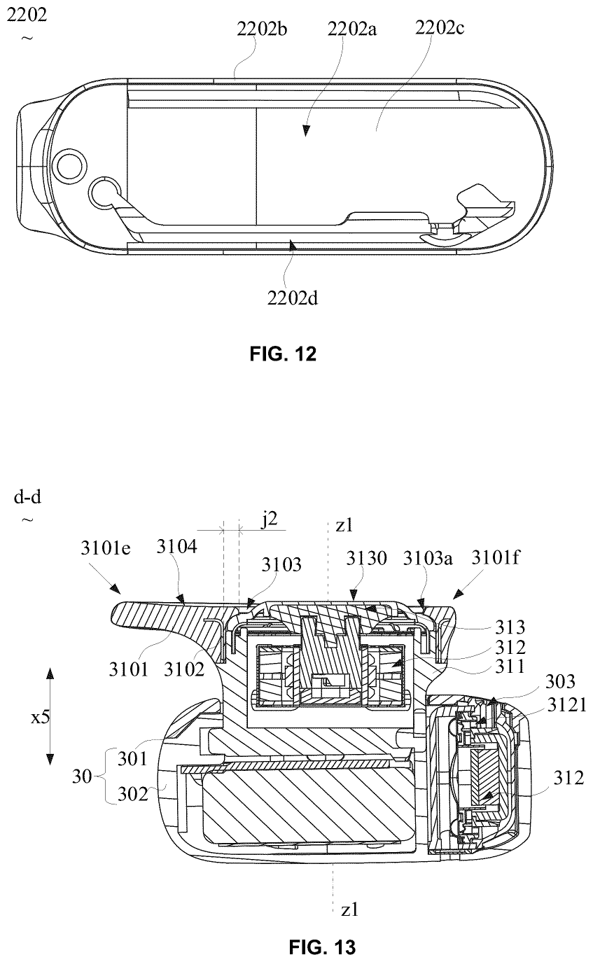

Specifically, as shown in FIG. 8 and FIG. 12, in some embodiments, an extension wall 2202b is disposed on a side of the housing 220 close to the head, and the extension wall 2202b and the housing 220 enclose to form a positioning groove 2202a. The side of the housing 220 close to the head in the wearing state forms a bottom wall 2202c of the positioning groove 2202a, the extension wall 2202b forms a sidewall of the positioning groove 2202a, and the soft abutment portion 223 may be detachably disposed in the positioning groove 2202a. This configuration can effectively improve an installation precision of the soft abutment portion 223, thereby effectively improving the wearing stability and the wearing comfort of the earphone 1. For example, in some embodiments, the first housing 2201 and the second housing 2202 cooperate with each other to form the housing 220. The second housing 2202 is disposed close to the head in the wearing state, and the positioning groove 2202a is disposed on the second housing 2202. That is, the second housing 2202 is provided with the extension wall 2202b and the bottom wall 2202c. The extension wall 2202b and the bottom wall 2202c enclose to form the positioning groove 2202a, which effectively improves the installation accuracy of the soft abutment portion 223, thereby effectively improving the wearing stability and the wearing comfort of the earphone 1.

Optionally, as shown in FIG. 8 and FIG. 12, in some embodiments, the wearing assembly 2 further includes the hook-and-loop fastener 222, and the hook-and-loop fastener 222 includes a hook patch (not shown) and a furry patch (not shown). One of the hook patch and the furry patch is disposed on the bottom wall 2202c of the positioning groove 2202a, and the other one is disposed on a side of the soft abutment portion 223 facing the housing 220. For example, in some embodiments, the hook patch is disposed on the bottom wall 2202c of the positioning groove 2202a, and the furry patch is disposed on the side of the soft abutment portion 223. Alternatively, for example, in some embodiments, the furry patch is disposed on the bottom wall 2202c of the positioning groove 2202a, and the hook patch is disposed on the side of the soft abutment portion 223. In this way, the soft abutment portion 223 is detachably connected to the housing 220 through the hook-and-loop fastener 222, thereby effectively improving the ease of loading and unloading the soft abutment portion 223.

Optionally, in some embodiments, the soft abutment portions 223 include at least two groups of soft abutment portions 223 (one group of soft abutment portions 223 includes two soft abutment portions 223 disposed on the two housings 220, respectively), and the thicknesses of the soft abutment portions 223 of different groups of wearing assemblies 2 may be different. Therefore, when facing different groups of users, the wearing adaptability and the wearing comfort of the earphone 1 may be adjusted by switching the soft abutment portions 223 with the corresponding thicknesses, thereby effectively improving the wearing adaptability of the earphone 1.

For example, in some embodiments, the earphone 1 includes three groups of soft abutment portions 223 with different thicknesses. Among the three groups of soft abutment portions 223, a thickness of each of first ends 223b of a first group of soft abutment portions 223 may be set to 3 mm, and a thickness of each of second ends 223c of the first group of soft abutment portions 223 may be set to 3.8 mm. A thickness of each of first ends 223b of a second group of soft abutment portions 223 may be set to 3.5 mm, and a thickness of each of second ends 223c of the second group of soft abutment portions 223 may be set to 4.5 mm. A thickness of each of first ends 223b of a third group of soft abutment portions 223 may be set to 4 mm, and a thickness of each of second ends 223c of the third group of soft abutment portions 223 may be set to 6 mm. This configuration can effectively improve the wearing adaptability of the earphone 1. Of course, in other embodiments, a plurality of groups of soft abutment portions 223 with different structural sizes may be disposed for the users according to actual needs, thereby effectively improving the wearing adaptability of the earphone 1.

Preferably, in some embodiments, each soft abutment portion 223 includes a sponge main body (not labeled in the figure) and a fabric (not labeled in the figure) wrapping the sponge main body, and a surface of the fabric is provided with dots or strips of silica gel distributed in an array. Specifically, the sponge main body is a main body of the soft abutment portion 223, which has an elastic buffer effect to effectively buffer the clamping force between the two connection assemblies 22, thereby effectively improving the wearing comfort of the earphone 1. The fabric wraps the sponge main body to allow the sponge main body to contact the side surface of the head through the fabric and the silicone disposed on the fabric to further improve the wearing comfort of the earphone 1. The dots or strips of silica gel are distributed in the array on the surface of the fabric. This configuration can effectively improve a friction force between the soft abutment portion 223 and the head, thereby effectively improving the wearing stability of the earphone 1.

Optionally, as shown in FIG. 8 and FIG. 12, in some embodiments, the wearing assembly 2 further includes a wire 215 threaded through the headband assembly 21 and the housing 220. The wire 215 is at least used to realize a circuit connection among the battery 34, the microphone, and the two speaker assemblies 3 of the earphone 1. Specifically, the bottom wall 2202c of the positioning groove 2202a is provided with a wiring groove 2202d, and the two ends (i.e., the first end 223b and the second end 223c of the housing 220) of the housing 220 along a telescoping direction of the telescoping assembly 221 are provided with a wire inlet and a wire outlet, respectively. The wire 215 is threaded into the positioning groove 2202a via the wire inlet, embedded in the wiring groove 2202d, and threaded out of the positioning groove 2202a via the wire outlet to connect to the corresponding components, such as, the speaker assemblies 3, the battery 34, the microphone, etc. This configuration can effectively improve an overall concealment of the wire 215, and effectively reduce an exposed length of the wire 215, thereby effectively improving the aesthetics of the earphone 1. And, the wiring groove 2202d is located within the positioning groove 2202a, so that when the wire 215 is arranged on the housing 220, the bottom wall 2202c of the positioning groove 2202a is spaced apart from the telescoping assembly 221. Therefore, the wire 215 can be effectively prevented from interfering with the telescoping adjustment of the telescoping assembly 221, thereby effectively ensuring a working stability of the telescoping assembly 221.

And, the bottom wall 2202c of the positioning groove 2202a is provided with the hook patch or the furry patch of the hook-and-loop fastener 222. Therefore, the hook patch or the furry patch of the hook-and-loop fastener 222 can hermetically seal the wire 215 in the wiring groove 2202d, thereby effectively improving the connection stability between the wire 221 and the housing 220. At the same time, when the soft abutment portion 223 is replaced, the hook patch or the furry patch of the hook-and-loop fastener 222 can also seal the wire 215 and the wiring groove 2202d, thereby effectively improving the concealment of the wire 215 and the wiring groove 2202d.

Optionally, in some embodiments, the wiring groove 2202d is also disposed on the side of the bottom wall 2202c away from the soft abutment portion 223. This configuration can conceal the wiring groove 2202d inside the housing 220, thereby effectively improving the concealment of the wire 215 and the wiring groove 2202d.

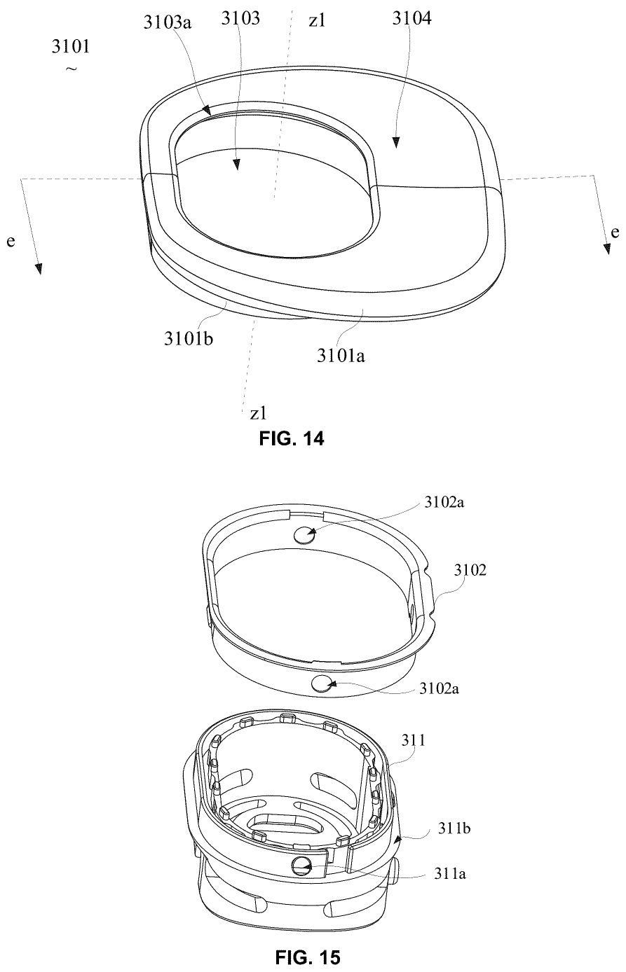

Preferably, as shown in FIG. 1, FIG. 2, FIG. 13, and FIG. 14, in some embodiments, one of the speaker assemblies 3, as set forth above, includes the housing assembly 30 and the bone conduction speaker 31. The bone conduction speaker 31 transmits the sound to the user through bone conduction. The bone conduction speaker 31 includes a core housing 311, a transducer 312, a vibration transmission contact assembly 313, and an auxiliary contact assembly 310. The core housing 311 is supported on the housing assembly 30, and at least a portion of the core housing 311 is exposed from the housing assembly 30. The transducer 312 is disposed inside the core housing 311. The vibration transmission contact assembly 313 is connected to the transducer 312, and contacts the facial region anterior to the user's tragus in the wearing state. The auxiliary contact assembly 310 includes a fixing ring 3102 and a silicone contact member 3101. The fixing ring 3102 is sleeved on the core housing 311, and the silicone contact member 3101 includes a contact main body 3101a and an annular flange 3101b sleeved on an outer ring surface of the fixing ring 3102. The contact main body 3101a is provided with a through hole 3103, and the annular flange 3101b is connected to a side of the contact main body 3101a facing the core housing 311 at a periphery of the through hole 3103. The vibration contact assembly 313 is exposed through the through hole 3103, and the contact main body 3101a contacts a facial region at a periphery of the vibration transmission contact assembly 313 in the wearing state.

Specifically, the bone conduction speaker 31 transmits the sound to the user's ear through bone conduction vibration. The transducer 312 is a device for converting electrical signals into vibrations, which is connected to the vibration conduction contact assembly 313 and drives the vibration conduction contact assembly 313 to vibrate based on the electrical signals. A vibration direction of the vibration transmission contact assembly 313 is also referred to as a bone conduction vibration direction x5, i.e., a vibration direction of the bone conduction speaker 31. The bone conduction vibration direction x5 is substantially parallel to the coronal axis of the human body in the wearing state. When the earphone 1 is in the wearing state, the vibration transmission contact assembly 313 directly or indirectly contacts the facial region anterior to the user's tragus. Driven by the transducer 312, the vibration transmission contact assembly 313 transmits the sound to the user through the bone conduction vibration.

Furthermore, the auxiliary contact assembly 310 plays a role of auxiliary support. In the wearing state, the auxiliary contact assembly 310 contacts the facial region anterior to the user's tragus to play the role of auxiliary support for the bone conduction speaker 31 along the bone conduction vibration direction x5. Based on this, a support pressure of a vibration plate on the face along the vibration direction can be effectively relieved, so that a work load of the transducer 312 is effectively reduced, thereby effectively ensuring the sound quality of the bone conduction speaker 31. In addition, when viewed along the bone conduction vibration direction x5, the auxiliary contact assembly 310 surrounds the periphery of the vibration transmission contact assembly 313 along a circumferential direction of the vibration transmission contact assembly 313. Based on this, the auxiliary support of the auxiliary contact assembly 310 can be provided to the periphery of the vibration transmission contact assembly 313, thereby effectively improving a positioning effect of the auxiliary contact assembly 310 on the vibration transmission contact assembly 313.

Further, as shown in FIG. 2 and FIG. 13, the auxiliary contact assembly 310 includes the fixing ring 3102 for rigid support, and also includes the silicone contact member 3101 for softly contacting the user's face. In the wearing state, while the auxiliary contact assembly 310 softly contacts the facial region anterior to the user's tragus through the silicone contact member 3101, the hard support is provided by the fixing ring 3102. This configuration can effectively ensure a support capability of the auxiliary contact assembly 310, and also effectively improve a softness of the auxiliary contact assembly 310, thereby effectively improving the wearing comfort of the earphone 1. The fixing ring 3102 is sleeved on the core housing 311, and the silicone contact member 3101 is fixedly connected to the fixing ring 3102 through the annular flange 3101b. Therefore, the entire auxiliary contact assembly 310 surrounds the periphery of the vibration transmission contact assembly 313, so that the periphery of the vibration transmission contact assembly 313 is supported by the auxiliary contact assembly 310, thereby effectively improving the positioning effect of the auxiliary contact assembly 310 on the vibration transmission contact assembly 313. In addition, the annular flange 3101b is sleeved on the outer annular surface of the fixing ring 3102, so that the entire fixing ring 3102 is concealed between the silicone contact member 3101 and the core housing 311 by the silicone contact member 3101, thereby effectively improving the concealment of the fixing ring 3102. Therefore, the appearance consistency of the auxiliary contact assembly 310 and the aesthetics of the earphone 1 can be effectively improved.

Optionally, as shown in FIG. 15, in some embodiments, an outer wall surface of the core housing 311 and an inner annular surface of the fixing ring 3102 are respectively provided with clamping structures that cooperate with each other. For example, in some embodiments, the clamping structures include a buckle 311a disposed on the outer wall surface of the core housing 311 and a socket 3102a disposed on the inner annular surface of the fixing ring 3102. In this way, the fixing ring 3102 can be clamped on the core housing 311, thereby effectively improving the connection stability between the fixing ring 3102 and the core housing 311, and effectively improving the assembly efficiency.

Preferably, as shown in FIG. 14, in some embodiments, the contact main body 3101a and the annular flange 3101b are an integrally molded member. This configuration can effectively improve the appearance consistency of the silicone contact member 3101, thereby effectively improving the aesthetics of the earphone 1. Furthermore, the silicone contact member 3101 is fixed to the fixing ring 3102 by molding, thereby effectively improving the appearance consistency of the auxiliary contact assembly 310, and effectively improving a production efficiency of the auxiliary contact assembly 310.

Preferably, as shown in FIG. 13, in some embodiments, along a direction facing a middle portion of the through hole 3103 (i.e., a direction parallel to the bone conduction vibration direction x5, and the middle portion of the through hole 3103 may be understood as a region of the through hole 3103 close to a central axis direction z1 of the through hole 3103), a hole edge 3103a of the through hole 3103 is disposed closer to the middle portion of the through hole 3103 with respect to the inner annular face of the fixing ring 3102 (i.e., a distance between the hole edge 3103a of the through hole 3103 and the middle portion of the through hole 3103 is smaller than a distance between the inner annular surface of the fixing ring 3102 and the middle portion of the through hole 3103). In this way, the silicone contact member 3101 can conceal a connection gap between the fixing ring 3102 and the core housing 311 from the direction facing the middle portion of the through hole 3103, thereby effectively improving the aesthetics of the earphone 1.

Further, as shown in FIG. 13, along the direction facing the middle portion of the through hole 3103 (i.e., along the direction perpendicular to the center axis direction z1), a spacing distance j2 between the hole edge 3103a of the through hole 3103 and the inner annular surface of the fixing ring 3102 is within a range from 1 mm to 3 mm. For example, the spacing distance j2 may be set as any value within the range from 1 mm to 3 mm, such as, 1 mm, 1.5 mm, 2 mm, 2.5 mm, 3 mm, etc. Therefore, the silicone contact member 3101 can conceal the connection gap between the fixing ring 3102 and the core housing 311 from the direction facing the middle portion of the through hole 3103. At the same time, the silicone contact member 3101 can be effectively prevented from interfering with the vibration transmission contact assembly 313, thereby effectively improving the sound transmission effect of the bone conduction speaker 31.

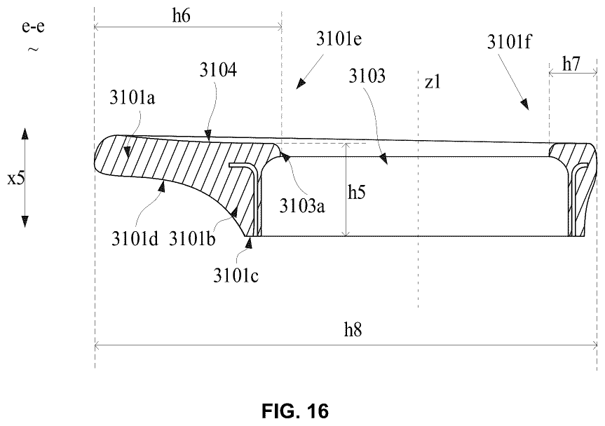

Preferably, as shown in FIG. 13 and FIG. 16, the contact main body 3101a is provided with a contact surface 3104 for contacting the facial region of the user. In the natural state, the contact surface 3104 extends toward a side of the vibration transmission contact assembly 313 away from the housing assembly 30 with respect to the vibration transmission contact assembly 313. Specifically, in some embodiments, in the natural state, viewed along an observation direction perpendicular to the bone conduction vibration direction x5, the contact surface 3104 is gradually recessed toward the side of the housing assembly 30 in a direction from an outer circumferential edge of the contact surface 3104 to the hole edge 3103a of the through hole 3103. In this way, the contact main body 3101a is arranged in a sucker structure. This configuration can effectively improve a contact compactness between the contact main body 3101a and the user's facial region, thereby effectively minimizing a risk of a movement of the speaker assembly 3 with respect to the user's facial region during the working process, and effectively improving the wearing stability of the earphone 1. Moreover, in this way, a deformation space of the contact main body 3101a along the bone conduction vibration direction x5 can be enhanced. That is, there is a sufficiently large spacing distance between the outer circumferential edge of the contact surface 3104 and the hole edge 3103a of the through hole 3103 along the bone conduction vibration direction x5. As the contact main body 3101a is relatively softer than the vibration contact assembly 313, when the earphone 1 is in the wearing state, the larger deformable space makes the contact surface 3104 and a side of the vibration contact assembly 313 facing the facial region (i.e., a contact surface 3130) flush with each other and contact the face, so as to ensure that the auxiliary contact assembly 310 has a sufficiently great auxiliary support force, thereby effectively relieving a supporting pressure of the vibration transmission contact assembly 313 along the bone conduction vibration direction x5, and effectively reducing the work load of the transducer 312. At the same time, this configuration can effectively ensure that the contact main body 3101a provides a sufficiently comfortable elastic buffer for the speaker assembly 3, so as to effectively buffer the clamping force of the wearing assembly 2, thereby effectively improving the wearing comfort of the earphone 1. For example, in some embodiments, the vibration transmission contact assembly 313 is provided with the contact surface 3130 for contacting the user and transmitting the vibrations. When the earphone 1 is in the wearing state, along the bone conduction vibration direction x5, the contact surface 3130 is located between the outer circumferential edge of the contact surface 3104 and the hole edge 3103a of the through hole 3103. Alternatively, the contact surface 3130 flushes with the hole edge 3103a of the through hole 3103. Therefore, in the natural state, the entire contact main body 3101a protrudes with respect to the contact surface 3130 along the bone conduction vibration direction x5, and in the wearing state, the contact main body 3101a deforms along the bone conduction vibration direction x5 under the action of the clamping force of the wearing assembly 2. When a force balance is reached, the contact surface 3130 flushes with the contact surface 3104, thereby effectively relieving the support pressure of the vibration transmission contact assembly 313 along the bone conduction vibration direction x5, and effectively reducing the work load of the transducer 312. At the same time, this configuration can effectively ensure that the contact main body 3101a provides the sufficiently comfortable elastic buffer for the speaker assembly 3, so as to effectively buffer the clamping force of the wearing assembly 2, thereby effectively improving the wearing comfort of the earphone 1.

Preferably, as shown in FIG. 13 and FIG. 16, in some embodiments, in an observation plane along the observation direction (perpendicular to the bone conduction vibration direction x5), the contact main body 3101a has a thickness size h5 extending along the bone conduction vibration direction x5. The thickness size h5 is the spacing distance between the contact surface 3104 and the end surface 3101c of the contact main body 3101a along the bone conduction vibration direction x5. The thickness of the contact main body 310a gradually decreases along the direction away from the through hole 3101. Alternatively, the thickness of the contact main body 310a gradually increases and then decreases along the direction away from the through hole 3101. For example, in some embodiments, the thickness size h5 of the contact main body 3101a starts at the hole edge 3103a of the through hole 3103, and gradually increases and then decreases along a positive direction from the hole edge 3103a of the through hole 3103 to the outer circumferential edge of the through hole 3103. The maximum value of the thickness size h5 of the contact main body 3101a is located at a connection between the contact main body 3101a and the fixing ring 3102. Alternatively, in some embodiments, in the observation plane along the observation direction, an outer surface 3101d of the contact main body 3101a gradually decreases along a direction toward the housing assembly 30. That is, a radial size h8 (i.e., a size perpendicular to the bone conduction vibration direction x5) of the outer surface 3101d of the contact main body 3101a gradually decreases along a positive direction facing the housing assembly 30 of the bone conduction vibration direction x5. Based on this, the entire contact main body 3101a conforms to a physical structure that is subjected to a compressive deformation along the direction of the bone conduction vibration direction x5, which effectively improves a buffer capacity of the contact main body 3101a and effectively reduces the structural size of the contact main body 3101a, thereby effectively reducing an overall mass of the speaker assembly 3.

Preferably, as shown in FIG. 15 and FIG. 16, in some embodiments, an outer periphery of the core housing 311 is provided with an annular contact portion 311b. Along the bone conduction vibration direction x5, the end surface 3101c of the contact main body 3101a and one end of the fixing ring 3102 contact the annular contact portion 311b, respectively. In this way, the connection stability between the auxiliary contact assembly 310 and the core housing 311 can be effectively increased. Furthermore, in some embodiments, a position where the end surface 3101c of the contact main body 3101a overlaps with the annular contact portion 311b has a maximum thickness size.

In this way, the clamping force transmitted from the core housing 311 to the contact main body 3101a acts on a location where deformation along the bone conduction vibration direction is easily triggered, thereby enhancing the cushioning capacity of the contact main body 3101a, and effectively improving the wearing stability of the earphone 1.

Preferably, as shown in FIG. 13 and FIG. 16, in some embodiments, in the wearing state, the contact main body 3101a has a first side 3101f facing the tragus and a second side 3101e away from the tragus. A ratio of a width h7 of the first side 3101f to a width h6 of the second side 3101e is within a range from 0.1 to 0.2. If the ratio is too large, a distance between the vibration transmission contact assembly 313 and the tragus increases, which affects the sound transmission effect of the bone conduction speaker 31. If the ratio is relatively small, a structure strength of the first side 3101f of the contact main body 3101a and an effective contact region between the user's face and the first side 3101f of the contact main body 3101a are relatively small, which not only affects the positioning accuracy of the vibration transmission contact assembly 313, but also affects the wearing comfort of the earphone 1. Therefore, the above ratio is within the range from 0.1 to 0.2. For example, the ratio may be set as any value within the range from 0.1 to 0.2, such as, 0.1, 0.11, 0.15, 0.2, etc. This configuration can effectively ensure the sound transmission effect of the bone conduction speaker 31, and also effectively improve the wearing comfort of the earphone 1 and the positioning accuracy of the vibration transmission contact assembly 313. Moreover, based on this, this configuration can also effectively prevent the silicone contact member 3101 from blocking a cavum concha. In an embodiment where the speaker assembly 3 is provided with the air conduction speaker 32, this configuration can better transmit the sound into the ear canal within the cavum concha through an external sound outlet hole of the air conduction speaker 32 (i.e., a second sound outlet 303 described below), thereby effectively improving the sound transmission effect of the air conduction speaker 32, and effectively improving the sound quality of the earphone 1.

Preferably, as shown in FIG. 16, in some embodiments, the width h7 of the first side 3101f is within a range from 0.5 mm to 3 mm. For example, the width h7 of the first side 3101f may be set as any value within the range from 0.5 mm to 3 mm, such as, 0.5 mm, 1.0 mm, 1.5 mm, 2.0 mm, 3.0 mm, etc., thereby effectively ensuring the sound transmission effect of the bone conduction speaker 31, and effectively improving the wearing comfort of the earphone 1 and the positioning accuracy of the vibration transmitting contact assembly 313.

Optionally, as shown in FIG. 13, in some embodiments, the speaker assembly 3 also includes the air conduction speaker 32. The air conduction speaker 32 is disposed within the housing assembly 30, and the air conduction speaker 32 is provided with a first sound outlet 3121. The housing assembly 30 is provided with the second sound outlet 303 corresponding to the first sound outlet 3121. Viewed along the vibration direction of the vibration transmission contact assembly 313 (also referred to as the bone conduction vibration direction x5), the second sound outlet 303 is located at a periphery of the silicone contact member 3101. The second sound outlet 303 is disposed on a side of the silicone contact member 3101 facing the tragus in the wearing state. Based on this, the second sound outlet 303 can be set closer to the cavum concha in the wearing state, so as to effectively improve the sound transmission effect of the air conduction speaker 32, thereby effectively improving the sound quality of the earphone 1.

Optionally, as shown in FIG. 13, in some embodiments, the housing assembly 30 includes the main housing 302 and the main cover body 301. The main housing 302 forms an accommodation space with an opening. The bone conduction speaker 31 and the air conduction speaker 32 are disposed in the accommodation space, and the main cover body 302 covers the opening of the accommodation space. The main cover body 301 is provided with a port, and at least the auxiliary contact assembly 310 and the vibration transmission contact assembly 313 of the bone conduction speaker 31 are exposed to the outside of the housing assembly 30 through the port to contact the user's face. The second sound outlet 303 is disposed on the main cover body 301 and located on a side of the main cover body 301 close to the cavum concha, thereby improving the sound transmission effect of the air conduction speaker 32.

The above descriptions are only a portion of embodiments of the present disclosure, and are not intended to limit the scope of the present disclosure. Any equivalent device or equivalent process transformed using the contents of the specification of the present disclosure and the accompanying drawings, or directly or indirectly applied in other related technical fields, are all included in the scope of the present disclosure.

1-34. (canceled)

35. A speaker assembly, comprising a housing assembly and a bone conduction speaker, wherein
the bone conduction speaker includes a core housing, a transducer, a vibration transmission contact assembly, and an auxiliary contact assembly,
the core housing is supported on the housing assembly, and at least a portion of the core housing is exposed from the housing assembly;
the transducer is disposed inside the core housing;
the vibration transmission contact assembly is connected to the transducer, and the vibration transmission contact assembly contacts a facial region anterior to a user's tragus in a wearing state,
the auxiliary contact assembly includes a fixing ring and a silicone contact member, the fixing ring being sleeved on the core housing, and the silicone contact member including a contact main body and an annular flange sleeved on an outer annular surface of the fixing ring,
the contact main body is provided with a through hole, the annular flange is connected to a side of the contact main body facing the core housing at a periphery of the through hole, the vibration transmission contact assembly is exposed through the through hole, and the contact main body contacts the facial region at a periphery of the vibration transmission contact assembly in the wearing state.

36. The speaker assembly of claim 35, wherein in the wearing state, the contact main body has a first side facing the tragus and a second side away from the tragus, and a ratio of a width of the first side to a width of the second side is within a range from 0.1 to 0.2.

37. The speaker assembly of claim 36, wherein the width of the first side is within a range from 0.5 mm to 3 mm.

38. The speaker assembly of claim 35, wherein an outer wall surface of the core housing and an inner annular surface of the fixing ring are respectively provided with clamping structures that cooperate with each other.

39. The speaker assembly of claim 35, wherein along a direction facing a middle portion of the through hole, a distance between a hole edge of the through hole and the middle portion of the through hole is smaller than a distance between the inner annular surface of the fixing ring and the middle portion of the through hole.

40. The speaker assembly of claim 39, wherein along the direction facing the middle of the through hole, a spacing distance between the hole edge of the through hole and the inner annular surface of the fixing ring is within a range from 1 mm to 3 mm.

41. The speaker assembly of claim 35, wherein the contact main body and the annular flange are integrally molded and are fixed to the fixing ring by molding.

42. The speaker assembly of claim 35, wherein in a natural state, a contact surface of the contact main body for contacting the facial region extends toward a side of the vibration transmission contact assembly away from the housing assembly.

43. The speaker assembly of claim 42, wherein a thickness of the contact main body gradually decreases along a direction away from the through hole, or
the other side of the contact main body away from the contact surface gradually decreases along a direction facing the housing assembly.

44. The speaker assembly of claim 35, further comprising an air conduction speaker disposed in the housing assembly, wherein
the air conduction speaker is provided with a first sound outlet,
the housing assembly is provided with a second sound outlet corresponding to the first sound outlet,
when viewed along a vibration direction of the vibration transmission contact assembly, the second sound outlet is located at a periphery of the silicone contact member, and
the second sound outlet is disposed on a side of the silicone contact member facing the tragus in the wearing state.

45. An earphone, comprising the speaker assembly of claim 35 and the wearing assembly connected to the speaker assembly, wherein
the wearing assembly is configured to position the speaker assembly at the facial region anterior to the user's tragus in the wearing state.

46. The speaker assembly of claim 42, wherein in the natural state, viewed along an observation direction, the contact surface is gradually recessed toward a side of the housing assembly in a direction from an outer circumferential edge of the contact surface to a hole edge of the through hole.

47. The speaker assembly of claim 42, wherein a thickness size of the contact main body along a vibration direction of the vibration transmission contact assembly gradually increases and then decreases along a direction away from the through hole.

48. The speaker assembly of claim 47, wherein a maximum value of the thickness size of the contact main body is located at a connection between the contact main body and the fixing ring.

49. The speaker assembly of claim 42, wherein a radial size of an outer surface of the contact main body gradually decreases along a positive direction facing the housing assembly of a vibration direction of the vibration transmission contact assembly.

50. The speaker assembly of claim 35, wherein an outer periphery of the core housing is provided with an annular contact portion, and
along a vibration direction of the vibration transmission contact assembly, an end surface of the contact main body and one end of the fixing ring contact the annular contact portion, respectively.

51. The speaker assembly of claim 44, wherein the housing assembly includes a main housing and a main cover body,
the main housing forms an accommodation space with an opening,
the bone conduction speaker and the air conduction speaker are disposed in the accommodation space, and
the main cover body covers the opening of the accommodation space.

52. The speaker assembly of claim 51, wherein
the main cover is provided with a port, and
the auxiliary contact assembly and the vibration transmission contact assembly of the bone conduction speaker are exposed to the outside of the housing assembly through the port to contact the user's face.

53. The speaker assembly of claim 52, wherein
the second sound outlet is disposed on the main cover body and located on a side of the main cover body close to the user's cavum concha.

54. The speaker assembly of claim 35, wherein the silicone contact member is fixedly connected to the fixing ring through the annular flange.
